(19) United States
(12) Patent Application Publication
(10) Pub. No.: US 2009/0161800 A1
(43) Pub. Date: Jun. 25, 2009

(54) METHOD AND APPARATUS FOR PACKET DETECTION

(75) Inventors: Kuo-Tai Chiu, Taoyuan County (TW); Chin-Hung Chen, Tainan City (TW); Chien-Yu Kao, Taipei County (TW); Pang-An Ting, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/125,919

(22) Filed: May 23, 2008

(30) Foreign Application Priority Data
Dec. 20, 2007 (TW) 96148978

(51) Int. Cl. H04L 27/06

(52) U.S. Cl. 375/343

(57) ABSTRACT

A present invention provides a method and an apparatus for packet detection. The packet detection method with adaptive strategy includes several stages, and each stage has different parameter setting for packet detection. The method provides the packet detection apparatus with adaptive advantage to adapt various channel environments. The method and an apparatus for packet detection can effectively promote the success probability to detect packets.

### CROSS-REFERENCE TO RELATED APPLICATION

This application claims the priority benefit of Taiwan application serial no. 96148978, filed on Dec. 20, 2007. The entirety of the above-mentioned patent application is hereby incorporated by reference herein and made a part of specification.

### BACKGROUND OF THE INVENTION

1. Field of the Invention

The present invention generally relates to a communication system, and more particularly, to a method and apparatus for packet detection.

2. Description of Related Art

In a communication system with packet pattern, prior to transmitting a payload, a transmitter would send out a preamble first for a receiver to conduct frame synchronization, packet detection and channel estimation, etc. Since the preamble usually is designed as a periodic signal, thus, a conventional receiver preferably uses delay correlation for detecting and identifying the part in which the just received signal is counted as a preamble. Once the preamble is detected, the packet and the starting position of a signal frame are located. In addition to the above-mentioned delay correlation, other common techniques of the conventional packet detection method are, for example, matched-filter technique, energy-detector technique and so on.

In the packet detection method employing the delay correlation approach, a threshold would be preset in advance, and the delay correlation values of a received signal will be computed. When the calculated delay correlation value is greater than the preset threshold, the receiver would conclude the preamble of a packet is detected. However, a sub-channelization likely causes a correlation within the payload received by the receiver as well, which may make the receiver wrongly conclude a preamble was detected and thereby a false alarm event occurs. On the other hand, when a receiver suffers an intense co-channel interference (CCI), the quality of the received signal is evidently degraded, which lowers the delay correlation value of the received signal, even makes the receiver fail to detect a preamble although the preamble does be received by the same receiver.

In the prior art, the US patent application No. 20050190786 provides an packet detection approach, where a false detection rate is uninterruptedly or periodically monitored, and then the parameters used in the packet detection method are adjusted according to the false detection rate.

### SUMMARY OF THE INVENTION

Accordingly, the present invention is directed to a method and an apparatus for packet detection to prevent any false alarm event and accurately detect a preamble in the packet.

The present invention is also directed to an packet detection method to detect a preamble in the packet. The method includes the following process steps. First, a received signal from a transmitter is received. Next, multiple sets of parameter are provided. Next, a first specific parameter among the sets of parameter is selected and a packet detection algorithm according to the selected first specific parameter is conducted. Another second specific parameter among the sets of parameter is reselected and a packet detection algorithm is conducted according to the selected second specific parameter when the spent time of the packet detection algorithm is greater than a preset time, wherein the packet detection algorithm calculates the signal characteristic and decides whether or not a preamble exists in the received signal according to the characteristic.

The present invention also provides an packet detection apparatus, which receives a received signal from a transmitter for detecting a preamble in the received signal. The packet detection apparatus includes a control unit and a detection unit, wherein the control unit provides multiple sets of parameter and selects a first specific parameter among the sets of parameter. The detection unit is coupled to the control unit and conducts a packet detection algorithm according to the first specific parameter selected by the control unit. The packet detection algorithm calculates the characteristic of the received signal and decides whether or not a preamble exists in the received signal. When the control unit concludes the spent time of the packet detection algorithm is greater than a preset time, another second specific parameter among the sets of parameter is re-selected and the detection unit re-conducts a packet detection algorithm according to the selected second specific parameter.

The embodiment of the present invention provides multiple sets of parameter so that the receiver is able to have multiple selections during performing the packet detection, which contributes to overcome the interferences in various channel environments to prevent false alarm events and accurately detect the preamble in a packet.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart of an packet detection method according to an embodiment of the present invention.

FIG. 2 is a flowchart of the step S150 in FIG. 1 according to the embodiment of the present invention.

FIG. 3 is a curve graph of delay correlation vs. sampling times.

FIG. 4 is a block diagram of an packet detection apparatus according to an embodiment of the present invention.

FIG. 5 is a curve graph of delay correlation vs. sampling times corresponding to a channel environment exposed to interference according to the embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

One example consistent with the invention provides a packet detection method for accurately detecting packets. For depiction convenience of the present invention, several assumptions are made in the embodiment. First, it is assumed that the packet detection technique is used in a receiver and applied to a communication system based on packet transmission pattern. Secondly, it is assumed that in a packet received by the receiver, the prefix data is a preamble followed by a payload. Therefore, once the receiver has detected a preamble, it is indicative that a packet is detected. Thirdly, the present embodiment also assumes the preamble contained by a packet is a periodic signal, which suggests the preamble has a large delay correlation value.

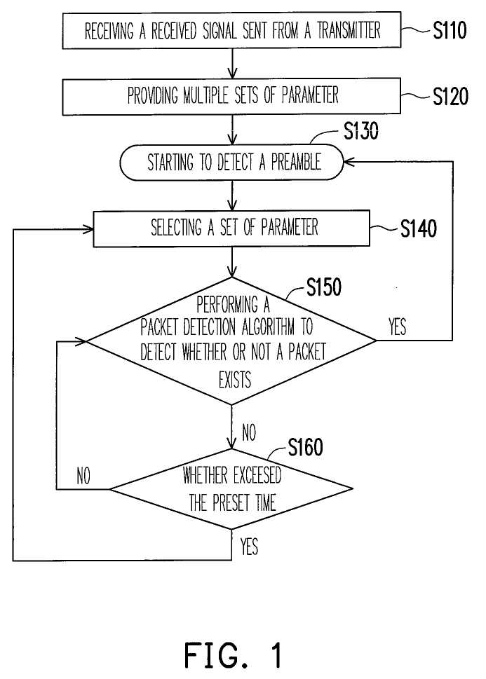

FIG. 1 is a flowchart of a packet detection method according to an embodiment of the present invention. Referring to FIG. 1, first, a receiver receives a signal from a transmitter (step S110), wherein the received signal is notated by rₖ and k represents a sampling time point and k is an integer. Next, the receiver provides multiple sets of parameter (step S120). Each set of parameter includes a sliding-window length, a threshold, a robust criterion and a preset time length, etc.

Next, the receiver starts detecting a preamble (step S130) and selects a set of parameter among multiple sets of parameter (step S140), wherein it is assumed a first specific parameter is selected in step S140. After that, the receiver would conduct a packet detection algorithm according to the first specific parameter so as to decide whether or not a packet exists (step S150). In the embodiment, the packet detection algorithm includes, for example, deciding how to detect a packet according to the characteristic of a preamble in the communication system. In the following, as described above, a preamble in the communication system is assumed to be a periodic signal. Accordingly, the packet detection algorithm includes using a delay correlation function to calculate the delay correlation value of the received signal and then decide whether or not a preamble exists in the received signal according to the calculated delay correlation value and furthermore to conclude whether or not a packet exists in the received signal.

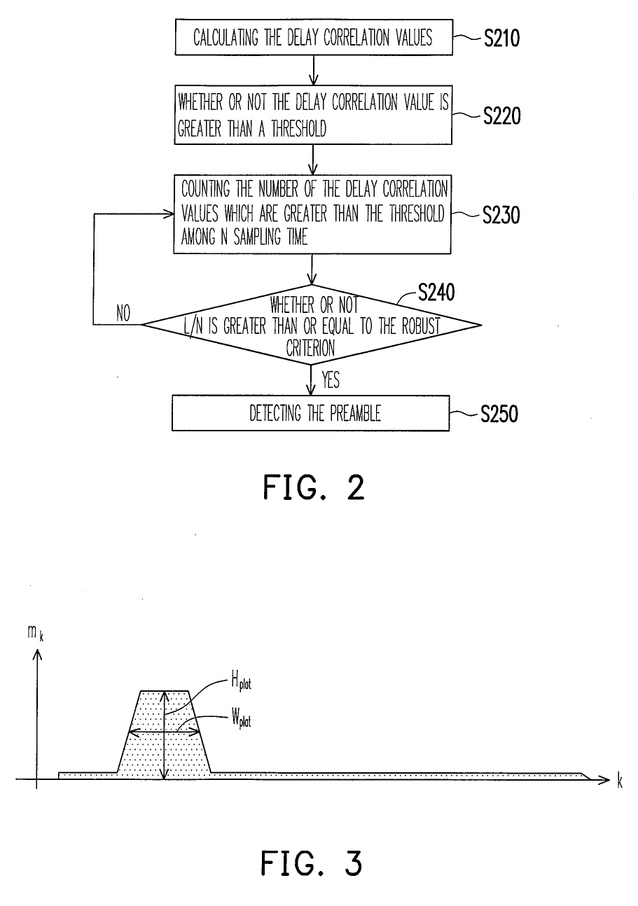

For depiction convenience, step S150 is further divided into a plurality of sub-steps, as shown by FIG. 2. Referring to FIG. 2, first, the delay correlation values of the received signal corresponding to each sampling time point are calculated (sub-step S210), wherein the delay correlation is notated by mₖ and the equation for calculating a delay correlation value could be as follows:

$${m}_{k} = \vert {\sum }_{i = 1}^{W} {r}_{k + i} {r}_{k + D + i}^{*} \vert , or$$

$${m}_{k} = \frac{\vert {\sum }_{i = 1}^{W} {r}_{k + i} {r}_{k + D + i}^{*} \vert}{{\sum }_{i = 1}^{W} ( \frac{{\vert {r}_{k + i} \vert}^{2} + {\vert {r}_{k + D + i} \vert}^{2}}{2} )} , or$$

$${m}_{k} = \frac{\vert {\sum }_{i = 1}^{W} {r}_{k + i} {r}_{k + D + i}^{*} \vert}{{( {\sum }_{i = 1}^{W} ( \frac{{\vert {r}_{k + i} \vert}^{2} + {\vert {r}_{k + D + i} \vert}^{2}}{2} ) )}^{2}} , or$$

other equations for calculating an auto-correlation function, wherein W represents a sliding-window length. Since step S140 has selected a first specific parameter; thus, for calculating the delay correlation value mₖ, the sliding-window length W is defined as the sliding-window length preset by the first specific parameter. D herein represents a delay length, which is equal to, for example, the period of the preamble, and the above-mentioned delay length D can be other value instead of the above-mentioned specific parameter, which should be decided according to the applied communication system.

It can be seen from the above-mentioned equations of delay correlation, if it is assumed there is no noise and interference in the channel and the payload in the packet is random, i.e., with a very low correlation, then, the delay correlation curve calculated by the receiver may be as shown by FIG. 3. Referring to FIG. 3, the abscissa herein represents sampling time point k and the ordinate represents delay correlation mₖ. As shown by FIG. 3, when the receiver has received a preamble and the delay correlation mₖ gets larger during the time duration of receiving a preamble, the curve of the delay correlation mₖ in FIG. 3 appears to be plateau-like, wherein the height of the plateau is Hₚₗₐₜ and the width of the plateau is Wₚₗₐₜ. That is to say, the delay correlation mₖ corresponding to a sampling time interval Wₚₗₐₜ is Hₚₗₐₜ. In terms of other sampling times, since the received signals are payloads, thus, the value of the delay correlation mₖ approaches zero, which means in order to ensure a preamble is detected, not only a larger value of the delay correlation mₖ must be detected, but also the sampling time with the larger value of the delay correlation mₖ must be kept for a while as well.

Accordingly, after calculating the delay correlation mₖ, the step of the method also includes a sub-step to sequentially judge whether or not the delay correlation mₖ corresponding to each sampling time point is greater than a threshold (sub-step S220) and count the number of the sampling time point corresponding to the delay correlation values mₖ greater than the threshold among the N sampling times (sub-step S230), wherein the counted sampling time point number is notated by L. Further, if L/N is greater than or equal to the robust criterion, it is judged that the receiver has detected a preamble contained in the received signal (sub-step S250). Otherwise, if L/N is less than the robust criterion (sub-step S240), the flowchart returns back to sub-step S230 to continuously count the sampling time point number corresponding to the delay correlation values mₖ greater than the threshold. In addition, since a first specific parameter has been selected at the time, thus, the above-mentioned threshold and robust criterion are the preset threshold and robust criterion in the first specific parameter.

Back to FIG. 1, in step S150, if a preamble is detected, it indicates the received signal at the time contains a packet, and the receiver can start using the received preamble to conduct a frame synchronization and channel estimation or other operations. Following, it should return to step S130 to re-wait and detect a next preamble. In contrast, if a preamble is not detected in step S150, the receiver needs to judge whether the spent time by performing the packet detection algorithm is greater than a preset time (step S160). If the spent time by performing the packet detection algorithm does not exceeds the preset time, the flowchart returns back to step S150 and another packet detection algorithm is executed. In contrast, if step S160 judges the spent time by performing the packet detection algorithm exceeds the preset time, the flowchart returns back to step S140, where another set of second specific parameter is selected again so as to conduct the packet detection algorithm according to the selected second specific parameter.

Note that since a first specific parameter has been selected at the time, the above-mentioned preset time in step S160 is that defined by the first specific parameter. The preset time in the embodiment can be a frame number as well. For example, the preset time is defined as 10 frames, the above-mentioned packet detection algorithm is modified to detect whether a preamble exists within the 10 frames of the received signal. If after observing 10 frames and no preamble is detected, the flowchart returns back to step S140 to re-select another set of parameter.

In the embodiment, when all parameters are selected to conduct the packet detection algorithm but still no preamble is found, the receiver would wait for a specific time and then re-use the above-mentioned multiple sets of parameter to start performing a packet detection; or after adjusting the above-mentioned multiple sets of parameter, the receiver re-starts performing the packet detection. In the embodiment, if the operation of performing the packet detection does not find the preamble during the preset time, the receiver can directly select another set of parameter from the multiple sets of parameter to conduct the packet detection algorithm again. In addition, if the operation of performing the packet detection does not find the preamble, the receiver can also directly adjust the parameter and then conduct the packet detection algorithm according to the adjusted parameter.

Note that although the above-mentioned embodiment has described a feasible implementation of the packet detection method, but anyone skilled in the art should understand the designs of various communication systems are unique, therefore, the present invention is not limited by the above-mentioned implementation. In other words, once multiple sets of parameter are provided and an application conducts the packet detection by using different parameter, the application has fall in the scope of the present invention already.

For example, although the preamble in a communication system of the above-mentioned embodiment is assumed to be periodic, but the preamble is allowed to be a signal with other patterns, where the operation of performing the packet detection algorithm is by means of a correlation function to calculate the correlation between the received signal and the original preamble. Following, existing a preamble or not in the received signal can be decided according to the calculation result. In other words, a matched filter technique is used by the receiver to detect a packet. Moreover, the preamble in a communication system is allowed to be a signal with a large energy, where the operation of performing the conduct the packet detection algorithm is by using an absolute-value function to calculate the absolute value of the received signal. Following, it can be decided that whether or not a preamble exists in the received signal according to the calculation result. In other words, the receiver can use an approach of energy detector to detect the packet.

The above-mentioned packet detection method can be implemented through a software or hardware. In order to make anyone skilled in the art to better implement the present invention following the above embodiment, another embodiment of the present invention regarding a packet detection apparatus using the packet detection method is depicted as follows.

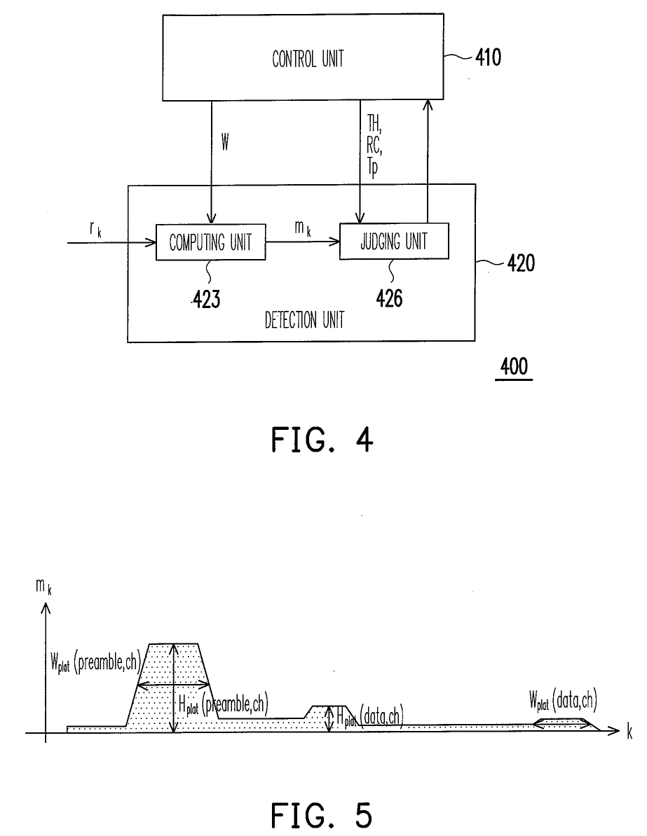

FIG. 4 is a block diagram of an packet detection apparatus according to an embodiment of the present invention. Referring to FIG. 4, a packet detection apparatus 400 includes a control unit 410 and a detection unit 420. The control unit 410 is able to provide multiple sets of parameter and selects a first specific parameter among the sets of parameter. The above-mentioned each parameter includes a sliding-window length W, a threshold TH, a robust criterion RC and a preset time Tp. The detection unit 420 is coupled to the control unit 410 and conducts a packet detection algorithm according to the first specific parameter selected by the control unit 410, and the packet detection algorithm is, for example, the same as that in the above-mentioned embodiment, thus the packet detection algorithm is omitted to describe.

The detection unit 420 further includes a computing unit 423 and a judging unit 426, wherein the computing unit 423 receives a received signal rₖ and the sliding-window length W in the first specific parameter selected by the control unit 410, and then computes the delay correlation mₖ corresponding to each sampling time point according to the sampling time point k and the sliding-window length W. The delay correlation mₖ is calculated by, for example, the same method as the above-mentioned embodiment and they are omitted to describe for simplicity. The judging unit 426 receives the delay correlation mₖ obtained by the computing unit 423 and the threshold TH, the robust criterion RC and the preset time Tp output from the control unit 410 and then judges whether or not a preamble exists in the received signal according to the delay correlation values mₖ. Since the way for the judging unit 426 to judge whether or not the received signal contains a preamble is similar to the sub-steps S220-S250, they are omitted to describe.

When the judging unit 426 concludes that a preamble exists in the received signal, the judgment result is sent to the control unit 410 so that the control unit 410 is informed of the received signal contained in a preamble, and a rear-stage circuit (not shown) starts performing timing synchronization or channel estimation etc. When the judging unit 426 fails to find a preamble in the preset time Tp, the judgment result is also sent to the control unit 410 so that the control unit 410 re-selects parameter and the detection unit 420 would conducts a packet detection again according to the updated parameter. It can be seen that the present embodiment uses multiple sets of parameter and divides the packet detection course into a plurality of stages, wherein each stage uses different parameter to sequentially conduct the operation of detecting a preamble for each stage. In other words, when the detection unit 420 is performing an operation in a stage, if the judging unit 426 judges the time spent for detecting the packet exceeds the preset time Tp, the control unit 410 is informed of skipping the procedure to the next stage for continuously performing a packet detection with an updated parameter.

During the transmission of a packet in a channel environment with interference, the height Hₚₗₐₜ and the width Wₚₗₐₜ in FIG. 3 would vary with the situation of the channel. FIG. 5 is a curve graph of delay correlation vs. sampling times corresponding to a channel environment exposed to interference according to the embodiment of the present invention. Referring to FIG. 5, the abscissa herein represents sampling time point k and ordinate represents delay correlation mₖ corresponding to a sampling time point. It can be seen from FIG. 5, in addition to a plateau of the curve of the delay correlation mₖ caused by a preamble, a bad channel would also cause a plateau on the curve of the delay correlation mₖ when the receiver receives the payload. For depiction convenience, the height of the produced plateau by the preamble is represented by Hₚₗₐₜ(preamble, ch) and the width thereof is represented by Wₚₗₐₜ(preamble, ch), while the height of the plateau produced by the payload is represented by Hₚₗₐₜ(data, ch) and the width thereof is represented by Wₚₗₐₜ(data, ch).

The real situation of the channel affects the width and the height of every plateau in FIG. 5, which further affects the design of the threshold TH and the robust criterion RC. Taking FIG. 5 as an example, the threshold TH should be defined between Hₚₗₐₜ(data, ch) and Hₚₗₐₜ(preamble, ch) and the robust criterion RC should be defined between Wₚₗₐₜ(data, ch) and Wₚₗₐₜ(preamble, ch). Once the threshold TH and the robust criterion RC are not suitable in the real channel environment, the receiver likely detects a packet in wrong way or misses a packet, which is called a false alarm event or a missing event.

One example consistent with the invention provides multiple sets of parameter and applies different parameter in different stages which are sequentially performing as mentioned above. Therefore, when a receiver has proper parameter to use, the receiver is able to accurately detect a preamble, wherein the multiple sets of parameter can be figured out in advance according to different types of channel environments, or after the receiver completes performing a stage, the receiver directly re-adjusts the parameter. Following, the next stage is performed according to the re-adjusted parameter.

Besides, according to the algorithm for computing the delay correlation mₖ, the sliding-window length W will affect the height Hₚₗₐₜ and width Wₚₗₐₜ of the plateau in FIG. 5. For example, with an increasing sliding-window length W, the height Hₚₗₐₜ (preamble, ch) produced by a preamble is only slightly decreased; in contrast, the height Hₚₗₐₜ produced by the payload is decreased significantly. Further, with an increasing sliding-window length W, the width Wₚₗₐₜ(preamble, ch) is increased, but the width Wₚₗₐₜ(data, ch) produced by the payload is decreased. On the other hand, the threshold TH and the robust criterion RC of the embodiment are designed in addition to considering various channel environment conditions but also to make the design values match the sliding-window length W.

In order to make anyone skilled in the art to better implement the present invention following the instruction of the above-mentioned embodiment, the embodiment provides the setting values of the parameter applicable to a worldwide interoperability for microwave access (WiMAX) system (conforming to the communication standard 802.16e), wherein the WiMAX system adopts orthogonal frequency division multiple access (OFDMA) approach, and the size of the used fast Fourier transform (FFT) is 1024. The structure of the preamble employed by a WiMAX system requires the above-mentioned delay length D to be set as 1024/3. Besides, the embodiment further provides two sets of parameter respectively used in different packet detection stage, and the sliding-window length W in the two sets of parameter is set as 170. Other parameters are set as shown by the following table:

| stage | threshold | robust criterion | preset time |
|---|---|---|---|
| 1 | 0.25 | 180/200 | 10 frame |
| 2 | 0.25 | 40/50 | 20 frame |

The robust criterion in the table is indicated by L/N, which means when all L delay correlation values within the observed N sampling times are greater than the threshold, the receiver would conclude a preamble is detected.

In fact, the first stage uses more stringent parameter. In other words, the parameter of the first stage is designed in accordance with a good channel environment. The parameter of the second stage is not stringent as that of the first stage, which means the parameter of the second stage is designed in accordance with a poor channel environment. In an application, the preamble, if it exists, is able to be detected by the receiver in the first stage or in the second stage regardless of a good channel environment or a poor channel environment. In addition, the computer simulations with the above-mentioned parameter prove the probabilities of false alarm events and packet missing events at a receiver are almost zero.

In summary, the present invention uses multiple sets of parameter and divides a packet detection course into a plurality of stages and each of the stages has different preset parameters for packet detection. Therefore, when a receiver sequentially conducts the stages one by one, the employed parameters are better matched with the present channel environment to enable the receiver accurately detecting a preamble with a lower occurrence rate of false alarm events.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An packet detection method, for detecting a preamble in the packet, comprising:
receiving a received signal sent from a transmitter;
providing multiple sets of parameter; and
selecting a first specific parameter among the parameter and performing a packet detection algorithm according to the first specific parameter.

2. The packet detection method according to claim 1, wherein the packet detection algorithm comprises calculating a specific function of the received signal according to the characteristic and to decide whether a preamble exists in the received signal according to the calculation result.

3. The packet detection method according to claim 2, wherein the specific function comprises a delay correlation function and the packet detection algorithm comprises calculating the delay correlation of the received signal to decide whether a preamble exists in the received signal according to the calculated delay correlation value.

4. The packet detection method according to claim 3, wherein each of the sets of parameter comprises a sliding-window length, a threshold and a robust criterion.

5. The packet detection method according to claim 4, wherein the step of calculating the delay correlation of the received signal comprises a step of calculating the delay correlation value corresponding to each sampling time point, notated by mₖ.

6. The packet detection method according to claim 5, wherein the step of deciding whether or not the preamble exists in the received signal according to the calculated delay correlation value comprises:
sequentially judging whether or not the delay correlation value mₖ corresponding to each sampling time point is greater than the threshold;
counting the number of the sampling times among N sampling times, wherein the delay correlation value mₖ corresponding to each the counted sampling time point is greater than the threshold, and the counted number is notated by L; and
concluding the preamble exists in the received signal when L/N is greater than or equal to the robust criterion.

7. The packet detection method according to claim 5, wherein each set of parameter comprises a delay length notated by D and a sliding-window length notated by W; wherein the received signal is represented by rₖ, wherein k represents a sampling time point and the delay correlation of the above-mentioned received signal is notated by mₖ, wherein mₖ is:
$${m}_{k} = \frac{\vert {\sum }_{i = 1}^{W} {r}_{k + i} {r}_{k + D + i}^{*} \vert}{{\sum }_{i = 1}^{W} ( \frac{{\vert {r}_{k + i} \vert}^{2} + {\vert {r}_{k + D + i} \vert}^{2}}{2} )} .$$

8. The packet detection method according to claim 5, wherein each set of parameter comprises a delay length notated by D and a sliding-window length notated by W; the received signal is represented by rₖ, wherein k represents a sampling time point and the delay correlation of the above-mentioned received signal is notated by mₖ, wherein mₖ is:
$${m}_{k} = \frac{\vert {\sum }_{i = 1}^{W} {r}_{k + i} {r}_{k + D + i}^{*} \vert}{{( {\sum }_{i = 1}^{W} ( \frac{{\vert {r}_{k + i} \vert}^{2} + {\vert {r}_{k + D + i} \vert}^{2}}{2} ) )}^{2}} .$$

9. The packet detection method according to claim 5, wherein each set of parameter comprises a delay length notated by D and a sliding-window length notated by W; the received signal is represented by rₖ, wherein k represents a sampling time point and the delay correlation of the above-mentioned received signal is notated by mₖ, wherein mₖ is:
$${m}_{k} = \vert {\sum }_{i = 1}^{W} {r}_{k + i} {r}_{k + D + i}^{*} \vert .$$

10. The packet detection method according to claim 1, wherein each set of parameter comprises a preset time which is used for setting the time spent by performing the packet detection algorithm, wherein when the time spent by performing the packet detection algorithm exceeds the preset time, a second specific parameter is re-selected among the parameter and the packet detection algorithm is conducted again according to the second specific parameter.

11. The packet detection method according to claim 10, wherein the preset time comprises a frame number.

12. The packet detection method according to claim 10, further comprising steps of adjusting the second specific parameter and performing the packet detection algorithm according to the adjusted second specific parameter after the step of selecting the second specific parameter.

13. The packet detection method according to claim 2, wherein the specific function comprises a correlation function and the packet detection algorithm comprises calculating the correlation between the received signal and an original preamble and decide whether the preamble exists in the received signal according to the calculated correlation value.

14. The packet detection method according to claim 2, wherein the specific function of an absolute-value function and the packet detection algorithm comprises calculating the absolute value of the received signal and decide whether the preamble exists in the received signal according to the calculated absolute value.

15. An packet detection apparatus, for receiving a received signal sent by a transmitter for detecting a preamble in the received signal, comprising:
a control unit, for providing multiple sets of parameter and selecting a first specific parameter among the parameter; and
a detection unit, coupled to the control unit for performing a packet detection algorithm according to the first specific parameter selected by the control unit.

16. The packet detection apparatus according to claim 15, wherein the packet detection algorithm comprises calculating a specific function according to the characteristic of the preamble and deciding whether or not the preamble exists in the received signal according to a calculation result; wherein when the control unit concludes the spent time of the packet detection algorithm is greater than a preset time, a second specific parameter among the sets of parameter is re-selected and the detection unit conducts the packet detection algorithm again according to the selected second specific parameter.

17. The packet detection apparatus according to claim 16, wherein the specific function comprises a delay correlation function and the packet detection algorithm comprises calculating the delay correlation of the received signal and to decide whether a preamble exists in the received signal according to the calculated delay correlation value.

18. The packet detection apparatus according to claim 17, wherein each of the sets of parameter comprises a sliding-window length, a threshold and a robust criterion.

19. The packet detection apparatus according to claim 18, wherein the detection unit comprises:
a computing unit for calculating the delay correlation value corresponding to each sampling time point according to the sampling time point, wherein the delay correlation value is represented by mₖ; and
a judging unit, for sequentially judging whether or not the delay correlation value mₖ corresponding to each sampling time point is greater than the threshold and counting the number of the sampling times among N sampling times, wherein the delay correlation values mₖ of the counted sampling times are greater than the threshold and the counted number is notated by L,
wherein when L/N is greater than or equal to the robust criterion, the judging unit concludes the received signal contains the preamble.

20. The packet detection apparatus according to claim 19, wherein each set of parameter further comprises a delay length represented by D and a sliding-window length represented by W; the received signal is represented by rₖ, wherein k represents a sampling time point and the delay correlation of the above-mentioned received signal is represented by mₖ, wherein mₖ is expressed by a following equation:
$${m}_{k} = \frac{\vert {\sum }_{i = 1}^{W} {r}_{k + i} {r}_{k + D + i}^{*} \vert}{{\sum }_{i = 1}^{W} ( \frac{{\vert {r}_{k + i} \vert}^{2} + {\vert {r}_{k + D + i} \vert}^{2}}{2} )} .$$

21. The packet detection apparatus according to claim 19, wherein each set of parameter further comprises a delay length represented by D and a sliding-window length represented by W; the received signal is represented by rₖ, wherein k represents a sampling time point and the delay correlation of the above-mentioned received signal is notated by mₖ, wherein mₖ is expressed by a following equation:
$${m}_{k} = \frac{{\vert {\sum }_{i = 1}^{W} {r}_{k + i} {r}_{k + D + i}^{*} \vert}^{2}}{{( {\sum }_{i = 1}^{W} ( \frac{{\vert {r}_{k + i} \vert}^{2} + {\vert {r}_{k + D + i} \vert}^{2}}{2} ) )}^{2}} .$$

22. The packet detection apparatus according to claim 19, wherein each set of parameter comprises a delay length represented by D and a sliding-window length represented by W; the received signal is represented by rₖ, wherein k represents a sampling time point and the delay correlation of the above-mentioned received signal is notated by mₖ, wherein mₖ is expressed by a following equation:
$${m}_{k} = \vert {\sum }_{i = 1}^{W} {r}_{k + i} {r}_{k + D + i}^{*} \vert .$$

23. The packet detection apparatus according to claim 16, wherein each set of parameter comprises a preset time for which is used for setting the time spent by performing the packet detection algorithm.

24. The packet detection apparatus according to claim 23, wherein the preset time comprises a frame number.

25. The packet detection apparatus according to claim 16, wherein the control unit is employed for adjusting the second specific parameter and the detection unit conducts the packet detection algorithm according to the adjusted second specific parameter.

26. The packet detection apparatus according to claim 16, wherein the specific function comprises a correlation function and the packet detection algorithm comprises calculating the correlation between the received signal and an original preamble and decide whether the preamble exists in the received signal according to the calculated correlation value.

27. The packet detection apparatus according to claim 16, wherein the specific function as an absolute-value function and the packet detection algorithm comprises calculating the absolute value of the received signal and decide whether the preamble exists in the received signal according to the calculated absolute value.
